(19) United States
(12) Patent Application Publication
(10) Pub. No.: US 2003/0132077 A1
(43) Pub. Date: Jul. 17, 2003

(54) Tuned mass damper using a hexapod

(76) Inventor: Toren S. Davis, Peoria, AZ (US)

Correspondence Address: Honeywell International Inc., Law Dept. AB2, PO Box 2245, Morristown, NJ, 07962-9806, US

(21) Appl. No.: 10/050,061

(22) Filed: Jan. 15, 2002

(51) Int. Cl. F16F 7/10

(52) U.S. Cl. 188/380

(57) ABSTRACT

A mass for use in creating a tuned mass damper for a structure is mounted on isolator struts that connect the mass and the structure in a hexapod pattern enabling predictable damping of said structure in all six degrees of freedom.

### BACKGROUND

A tuned mass damper (TMD) provides improved damping to structures and devices at a single frequency by tuning the damper's natural frequency to be at or close to the single frequency. TMDs are attached to the structure at an effective position, usually the anti-node, to counteract the device's vibration. The vibration stimulates the TMD to oscillator independently, 180 degrees out of phase, reducing the devices vibration. A TMD typically is adjusted at the factory by changing springs or removing material from the oscillating mass, estimating the frequency of the device to be damped. The typical TMD comprises a mass, a spring, and a damping means which form a system with a specific natural resonant frequency, and because of that structure, it is difficult to tune that frequency. The damping frequency

$${f}_{TMD} = \frac{1}{2 π} \sqrt{\frac{{k}_{TMD}}{{m}_{TMD}}} \qquad ( 1 )$$

is a function of the spring constant k to mass m ratio. It is not feasible to reduce completely the oscillations of the structure to which the TMD is attached because attenuation effect is a function of the ratio of the TMD mass to the structure mass.

As a practical matter, the oscillations of the device or structure commonly have to be damped in each orthogonal direction, presenting challenges in mounting a plurality of spring/dampers with one mass to a structure, as in U.S. Pat. No. 5,775,472, in lieu of the more expensive and heavier single axis TMD, as shown in U.S. Pat. No. 5,873,438, one for each direction. With a one mass TMD, like that described in U.S. Pat. No. 5,775,472, each spring/damper can have an effect on the others as the mass and structure move out of phase. This produces a mechanical system that is not “determinant”: the input and output function in any direction cannot be computed mathematically using known formulae due to the unpredictable effects of each damper/spring on the others.

### SUMMARY

As a solution to using a plurality of TMD's in each orthogonal direction, one mass is mounted on a “hexapod” of isolators (spring/damper) attached to the structure mass or device. A hexapod, as described in U.S. Pat. No. 5,305,981, has the characteristic of being a reliable and predictable mounting system where six rigid body modes can be adjusted and decoupled from each other by changing “strut” angles, stiffness, damping, and the TMD mass properties. A hexapod mounted TMD reduces the weight and volume required by utilizing the same mass and provides proper damping in all six degrees of freedom, three directions and three rotations.

Objects, benefits and features of the invention will be apparent to one of ordinary skill in the art from the drawing and following description.

### BRIEF DESCRIPTION OF THE DRAWING

FIG. 1 is a side view showing a mass connected to a structure by isolator struts in a hexapod according to the invention.

FIG. 2 is a section along 2-2 in FIG. 1.

FIG. 3 is a mechanical diagram illustrating the TMD associated with each isolator.

### DESCRIPTION

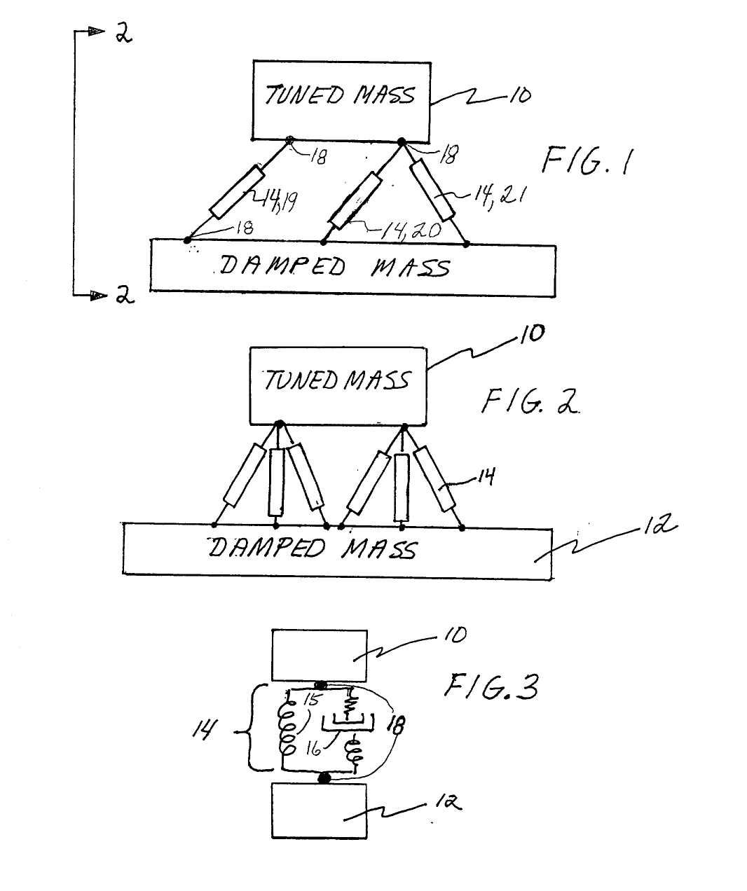

Referring to FIG. 1, a tuned mass 10 is employed to reduce oscillations of a structure, “damped mass” 12, by the using six isolator struts 14 connecting the mass 10 and damped mass 12 in a hexapod or “Stewart Platform” configuration. FIG. 3 shows that each strut 14 comprises a spring 15 and dashpot 16 in parallel, which combined with the mass 10 form a TMD along the spring (strut) extension axis. Each strut has spherical joint or pivot 18. These well-known struts 14 are traditionally used as isolators for shock absorption mounts for payloads on spacecraft, one type commonly known as the D-Strut brand isolator by Honeywell International Inc. The struts 14 have been used in a hexapod configuration for that purpose. The application and result are different in this arrangement, but with the predictable or deterministic mechanics of the hexapod, each strut 14 can be tuned with the one mass 10 to reduce particular frequencies alone or in combination with one or more other struts 14. This is because each strut 14 can move independently; that is, without extending the others, only requiring rotation at each strut's pivot point 18. By way of example, the mass 10 can rotate around the pivot 18 without extending the associated strut 14, even though other struts, for instance struts 20, 21, will extend. Consequently, the attenuation for each strut can be calculated, thus making it possible to finely tune each strut by adjusting its respective spring 15 constant and location for a particular structure (damped mass 12).. The one mass 10 and each strut 14 is a directional TMD, in effect, and vibrations in all six degrees of freedom, possibly differing in frequency, of damped mass 12 can be damped with a single TMD mass with predetermined inertia properties.

One skilled in the art may make modifications, in whole or in part, to a described embodiment of the invention and its various functions and components without departing from the true scope and spirit of the invention.

1. The combination comprising:
a structure;
a mass with predetermined inertia properties;
isolators connecting the structure and the mass in a hexapod configuration;
the mass and isolators being selected to provide tuned mass damping in all six degrees of freedom for the structure.

2. The combination described in claim 1, wherein:
the isolators comprise tubular damping struts with first and second spherical pivots at opposite ends of the tubular damping strut.

3. The combination comprising:
a structure;
a mass;
means for connecting the structure and the mass in a configuration that permits the mass and isolators to be deterministically selected to provide tuned mass damping in all six degrees of freedom for the structure.

4. The combination described in claim 3, wherein the means compromises isolators arranged in a hexapod.
